(19) United States
(12) Patent Application Publication
(10) Pub. No.: US 2018/0346258 A1
(43) Pub. Date: Dec. 6, 2018

(54) APPARATUS FOR ALIGNING PRODUCE IN ONE OR MORE LINES

(71) Applicant: Stuart Payne, Mount Waverley (AU)

(72) Inventors: Stuart PAYNE, Mount Waverley (AU); Ian PAYNE, Mount Waverley (AU)

(21) Appl. No.: 15/993,283

(22) Filed: May 30, 2018

(30) Foreign Application Priority Data
Jun. 1, 2017 (AU) 2017902208
Nov. 9, 2017 (AU) 2017904546

(51) Int. Cl. B65G 47/18; B65G 47/30

(52) U.S. Cl. CPC B65G 47/18; B65G 2201/047; B65G 47/30

(57) ABSTRACT

An apparatus for transforming a bulk flow of produce into a flow of produce aligned in one or more lines, to allow inspection for grading purposes at high speed, in particular by camera technology. The apparatus has a hopper which has differently configured opposing end portions arranged to allow the flow of produce from one end portion to the other, and wherein the exit end portion has at least one channel for guiding the produce therealong, wherein the at least one channel has a v-shaped cross-section defined by a pair of walls inclined upwardly away from each other so as to form a valley in which the produce is transportable by mechanical agitation into and along the valley such that the produce exits the hopper in one or more lines, one line from each of the at least one channel.

### BACKGROUND

### Technical Field

Embodiments of the present invention relate to an apparatus for transforming a bulk flow of produce into a flow of produce aligned in one or more lines.

### Description of the Related Art

When electronically grading fresh produce by camera technology, fresh produce is typically delivered at bulk volume and then aligned into lines by belt conveyors, also known in the industry as a ‘singulator’, for the purpose of being inspected by the camera technology. Grading at high speed with these belt conveyors is effective with medium or large produce however when used with smaller fragile produce, such as berries, the produce can become easily damaged, the belts collect orchard waste and produce liquid which disrupts operation and the produce do not form single lines effectively and accurately at these high speeds.

### BRIEF SUMMARY

According to some embodiments of the present invention, there is provided an apparatus for transforming a bulk flow of produce into a flow of produce aligned in one or more lines, the apparatus having at least one hopper which has differently configured opposing end portions arranged to allow the flow of produce from one end to the other, an entry end portion being adapted to receive the bulk produce and the exit end portion having at least one channel for guiding the produce therealong, wherein the at least one channel has a V-shaped cross-section defined by a pair of upwardly inclined walls forming a valley in which the produce is transportable by mechanical agitation from the entry end portion into and along the valley(s) such that the produce exits the hopper aligned in one or more lines, each line issuing from one of said at least one channel(s).

According to an embodiment, the hopper has two or more said channels.

According to an embodiment, the hopper has one or more guiding portion(s) intermediate the end portions, the or each guiding portion being adapted to guide the produce from the entry end portion into the respective channel(s).

According to an embodiment, the or each guiding portion is in the form of an inclined ramp which tapers in width into the respective channel(s).

According to an embodiment, the produce exiting the or each channel is adapted to be received on a respective conveyor for transportation to a grading system. Preferably, the conveyor is a roller conveyor.

According to an embodiment, the apparatus has one or more transition channels, each transition channel being intermediate the or each channel of the hopper and a respective conveyor wherein the or each transition channel is adapted to guide the produce therebetween.

According to an embodiment, the or each transition channel inclines downwardly from the channel of the hopper to the respective conveyor.

According to an embodiment, each transition channel has a V-shaped cross-section defined by a pair of upwardly inclined walls forming a valley in which the produce is transportable.

According to an embodiment, the apparatus has at least one air outlet arranged to deliver a flow of air, the or each air outlet being intermediate an exit end of the or each hopper channel and an entry end of the associated transition channel to direct air along the transition channel(s).

According to an embodiment, the or each conveyor is inclined upwardly from the or each respective channel or transition channel to prevent the produce from dropping from the channel(s) or transition channel(s) onto the associated conveyor.

According to an embodiment, the or each transition channel is mechanically-agitated.

According to an embodiment, the or each transition channel is non-agitated.

According to an embodiment, the inclination of the conveyor(s) is variable depending on the physical characteristics of the produce so as to allow each line of exiting produce to be drawn up onto the respective roller conveyor.

According to an embodiment, the entry end portion of the hopper has a pair of upright walls with a generally horizontal floor extending therebetween.

According to an embodiment, the apparatus has a further hopper, the further hopper being adapted to deliver the bulk produce into the first-mentioned hopper as a uniform flow.

According to an embodiment, the further hopper is mechanically agitated.

### BRIEF DESCRIPTION OF THE SEVERAL VIEWS OF THE DRAWINGS

Embodiments of the present invention will now be described, by way of non-limiting example only, with reference to the accompanying drawings, in which:

FIG. 1 is a perspective view of an apparatus for transforming a bulk flow of fresh produce into a flow of produce aligned in two lines in preparation for grading according an embodiment of the present invention;

FIG. 2 is a view of the apparatus of FIG. 1 transforming the bulk flow of produce;

FIGS. 3 and 4 are close up views of a first hopper and conveying system of FIGS. 1 and 2;

FIG. 5 is a side view of the apparatus of FIG. 1;

FIG. 6 is a perspective view of an apparatus for transforming a bulk flow of fresh produce into a flow of produce aligned in two lines in preparation for grading according to a further embodiment of the present invention;

FIG. 7 is a view of the apparatus of FIG. 1 transforming the bulk flow of produce;

FIGS. 8 and 9 are close up views of the apparatus of FIGS. 6 and 7; and

FIG. 10 is a side view of the apparatus of FIG. 6.

### DETAILED DESCRIPTION

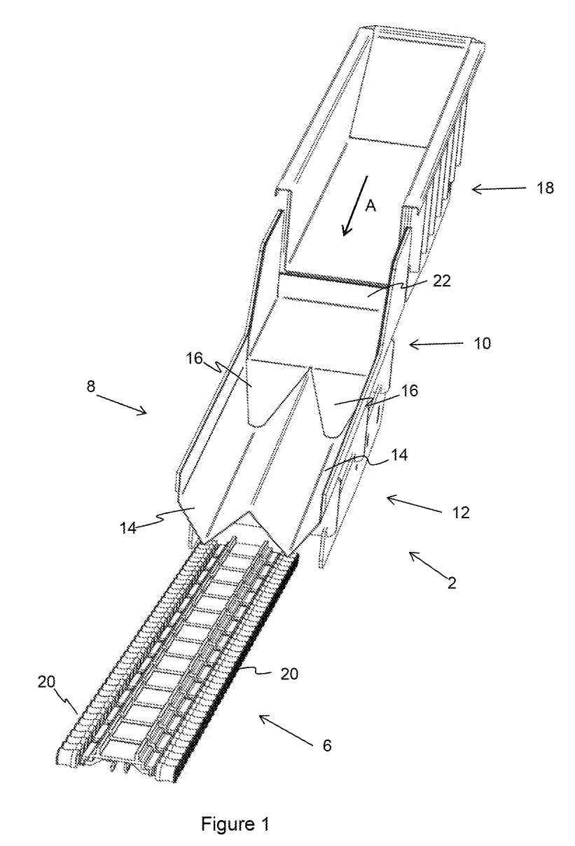

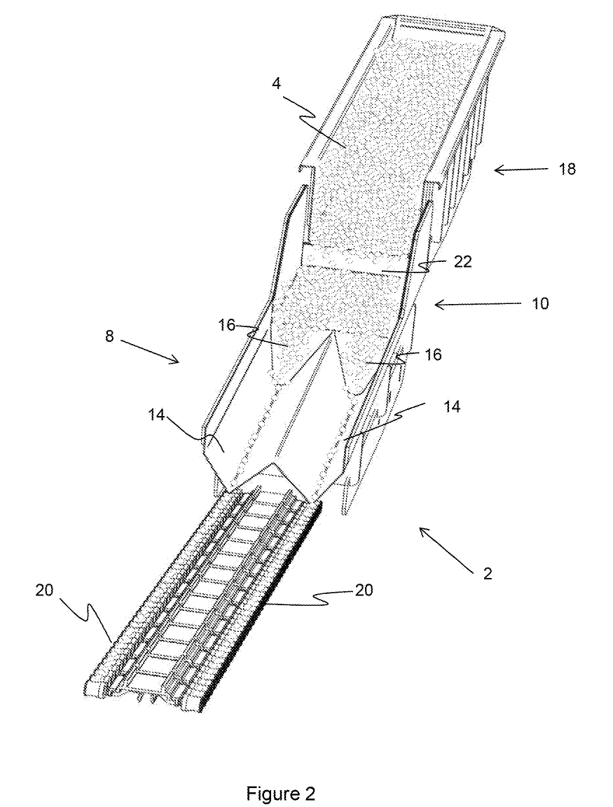

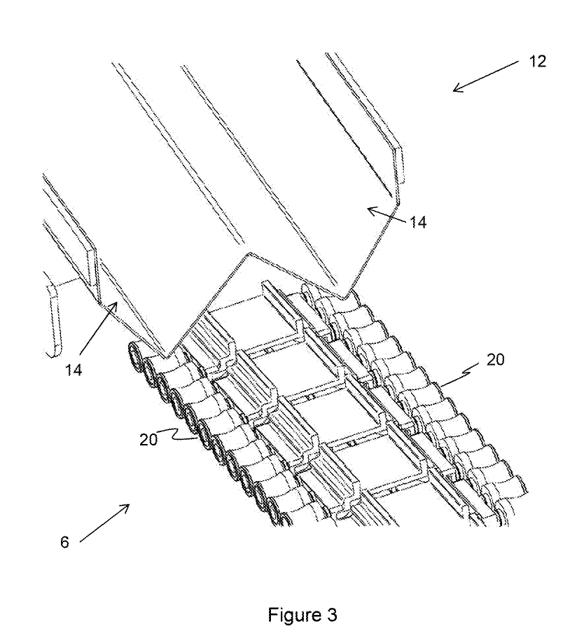

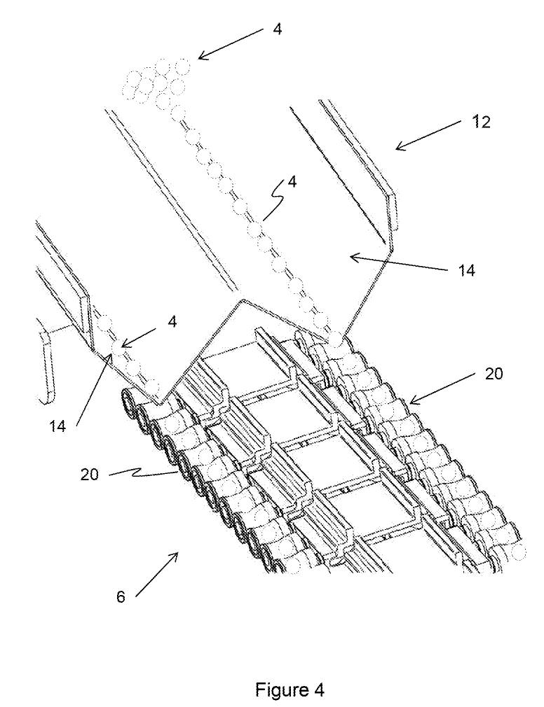

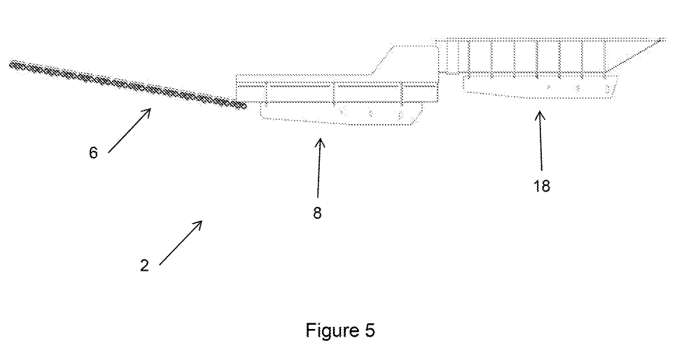

FIGS. 1 to 5 show various views of an apparatus 2 for transforming a bulk flow of produce 4 into a flow of produce 4 aligned in two lines according to an embodiment of the present invention. The flow of uniformly separated produce 4 can then be received on a conveying system 6 which then transports the produce 4 for the purpose of electronic grading by camera technology (not shown). The produce 4 can be substantially spherically-shaped fresh produce such as blueberries or other similar sized fruit or vegetables, as exemplified in FIGS. 2 and 4.

The apparatus 2 has a first hopper 8 having opposed end portions 10, 12 which are differently configured from each other. The first hopper 8 allows the flow of the produce 4 from an entry end portion 10 wherein the produce 4 enters in bulk form and exits at the exit end portion 12 arranged in one or more lines to be received onto the conveying system 6. The exit end portion 12 of the first hopper 8 has two channels 14, the channels 14 being adapted to guide the produce 4 from the entry end portion 10 and align the produce 4 into two lines when the first hopper 8 is mechanically agitated, each line exiting in single file from each of the two channels 14.

The channels 14 are arranged in side-by-side parallel configuration and have longitudinal axes substantially parallel to the flow of produce 4 as indicated by arrow A in FIG. 1. Each channel 14 has a V-shaped cross-section defined as a pair of walls upwardly inclined from each other, for instance at a 45° angle to the horizon, so as to form a valley such that the produce 4 is guided in the valley from one end of each channel 14 to the other to be arranged in a line. The angle between the walls can be modified depending on the physical characteristics of the produce 4 to ensure an efficient and effective flow of produce 4.

Although the apparatus 2 is exemplified in the Figures with two channels 14, the apparatus 2 can have a single or three or more channels which would function in the same way as the pair of channels 14 as discussed above. The number of channels can be increased or decreased depending on the physical characteristics of the produce 4 to ensure efficient and effective produce flow.

The entry end portion 10 of the first hopper 8 has a pair of upwardly directed walls with a generally horizontal floor therebetween. The first hopper 8 has guiding portions 16 intermediate the end portions 10, 12 which is adapted to guide the produce 4 from the entry end portion 10 to the exit end portion 12. The guiding portions 16, as exemplified in the Figures, is defined a pair of inclined ramps, each ramp tapering in width into a respective channel 14 so as to guide the produce 4 into the valley of each channel 14 such that the produce 4 settles behind one another in single file to form a line in the valley of each channel 14.

The apparatus 2 also has a second hopper 18 which is arranged to deliver bulk produce 4 into the entry end portion 10 of the first hopper 8. A transition portion 20 between the two hoppers 8, 18 facilities the flow therebetween and is defined as an inclined ramp to guide the produce 4 from second hopper 18 to the first hopper 8. By mechanically agitating the second hopper 18, bulk produce 4 is distributed evenly across the floor thereof so as to be received as a uniform flow into the entry end portion 10 of the first hopper 8. This ensures that the flow of the produce 4 is uniform before the channels 14 guide the produce 4 into lines, such that the produce 4 exits the channels 14 in a flow that is uniformly separated with a line of produce 4 exiting from each channel 14.

The apparatus 2 also has a conveying system 6 having two parallel driven roller conveyors 20, a first end of each roller conveyor 20 being arranged to receive a line of produce 4 from each channel 14. The roller conveyors 20 are inclined upwardly from the channels 14 such that the height of the channel valleys is substantially the height of the roller conveyors 20 so that the produce 4 transitions easily from the channels 14 to the respective roller conveyor 20 without dropping thereby preventing damage to the produce 4. The angle of inclination of the roller conveyors 20 can be varied depending on the physical characteristics of the produce to optimize the effectiveness of the drawing of the exiting produce onto the respective roller conveyor. As the produce 4 exits each channel 14, the respective roller conveyor 20 draws the produce 4, unit-by-unit, up onto the roller conveyor 20, which has a cup-like profile shaped to receive the produce 4 so that it can transported safely to the grading system.

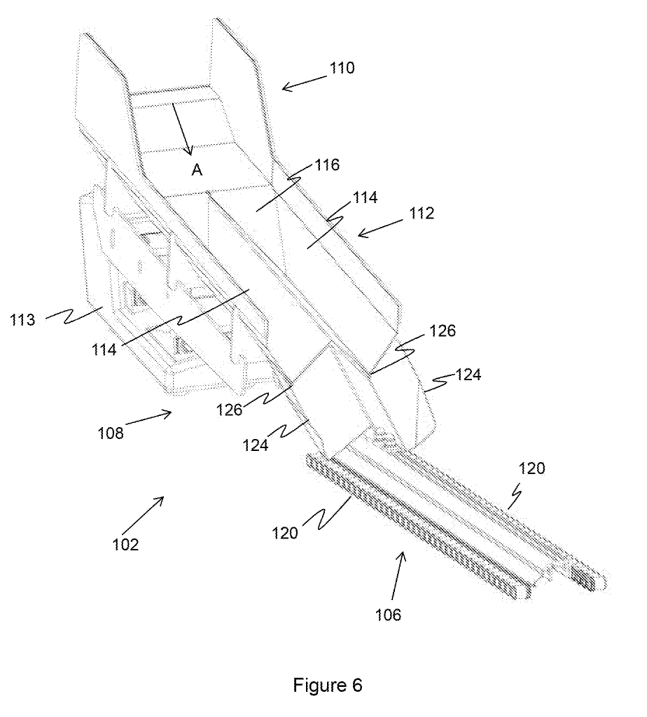

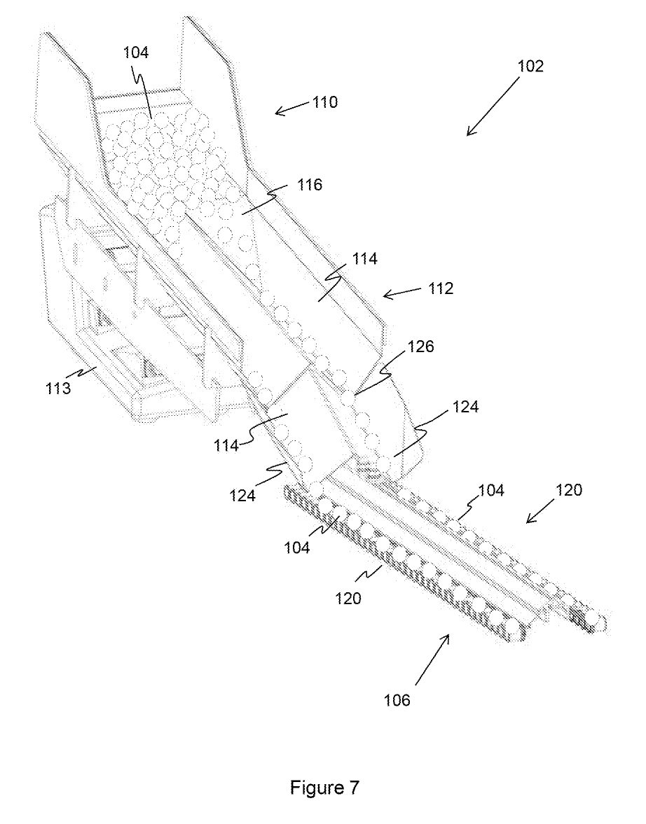

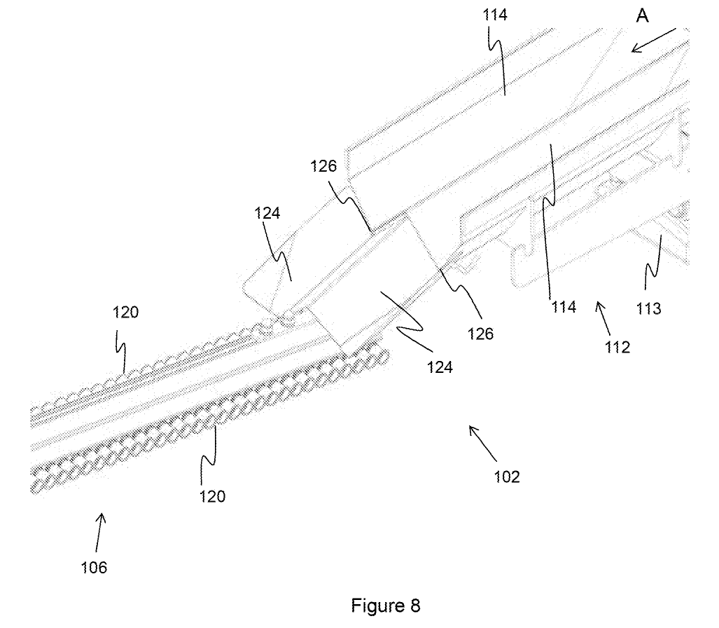

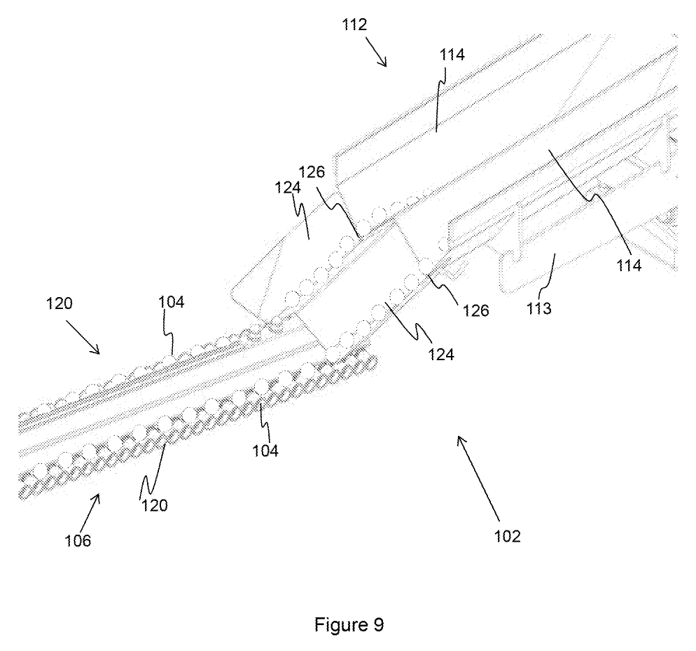

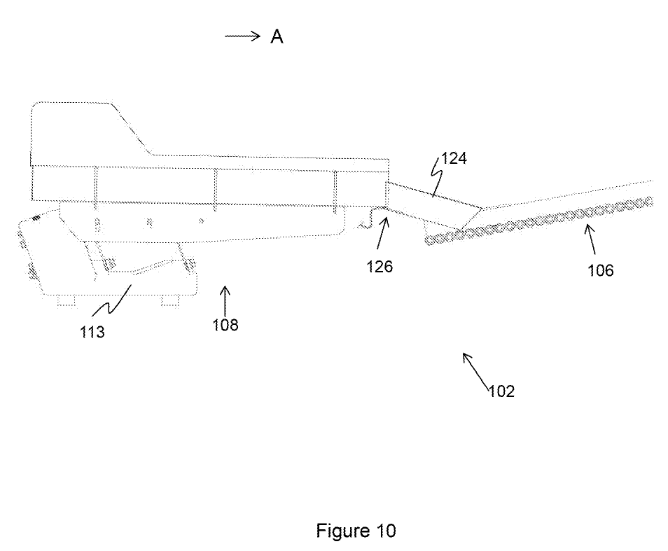

FIGS. 6 to 10 are views of an alternative apparatus 102 for transforming a bulk flow of produce 4 into a flow of produce 4 aligned in two lines according to another embodiment of the present invention. Apparatus 102 shares common features with apparatus 2 and like features are indicated with like numbers incremented by 100. To avoid repetition, the general description of apparatus 2 is intended to apply equally to these embodiments.

As illustrated in FIGS. 6 to 10, the apparatus 102 has a hopper 108 having opposed end portions 110, 112 which are differently configured from each other. The hopper 108 allows the flow of the produce 104 from an entry end portion 110 wherein the produce 104 enters in bulk form and exits at the exit end portion 112 arranged in one or more lines to be received onto the conveying system 106. The exit end portion 112 of the hopper 108 has two channels 114, the channels 114 being adapted to guide the produce 104 from the entry end portion 110 and align the produce 4 into two lines when the hopper 8 is mechanically agitated, by an agitation device 113, each line exiting in single file from each of the two channels 114.

The conveying system 106 has two parallel driven roller conveyors 120, and a pair of transition channels 124 intermediate the channels 114 and conveying system 106. Each transition channels 124 is inclines downwardly from the channels 114 to the conveying system 10. A first end of each transition channel 124 is arranged to receive a line of produce 104 from each respective channel 114. Each transition channel 124 has a v-shaped cross-section, and the walls of the transition channels 124 incline upwardly from each other to form a valley in which the produce 104 can be guided from the channels 114 of the hopper 108 to the conveying system 106. The transition channels 124 are not agitated and as such advantageously eliminates the bounce and random feed of the produce 104 which occurs when the produce is delivered directly from a mechanically agitated hopper to the conveying system. The presence of the transition channels 124 smooths the produce flow before it is received on the conveying system 106 and as such a second, mechanically-agitated or not, hopper may be included but is not necessary in this embodiment.

The apparatus 102 also has an air outlet 126 intermediate an exit end of each channel 114 and the entry end of the respective transition channel 124, wherein the air outlet 126 directing air along the associated transition channel 124. Each air outlet 126 delivers a flow of air which is substantially in the direction of the produce flow to increase the speed which assists to match the speed of the roller conveyors 120 so that the produce 104 easily transitions from the channel 124 to the roller conveyors 120. Thus the produce 104 can be transported to the conveying system 106 without dropping and further preventing damage to the produce 104. In a preferred embodiment, the transition channels 124 may be mechanically-agitated. Although the embodiment exemplified in FIGS. 6 to 10 discloses the air outlets 126, in an alternative embodiment the apparatus 102 may not include air outlets 126.

The angle of inclination of the roller conveyors 120 and the transition channels 124 can be varied depending on the physical characteristics of the produce 104 to optimize the effectiveness of the drawing of the exiting produce 104 onto the respective roller conveyor 120. As the produce 104 exits each transition channel 124, the respective roller conveyor 120 draws the produce 104, unit-by-unit, up onto the roller conveyor 120, which has a cup-like profile shaped to receive the produce 104 so that it can transported safely to the grading system.

Although two roller conveyors 20, 120 are exemplified in the Figures, if the first hopper 8, 108 has one or three or more channels 14, 114 the apparatus 2, 102 would have an equivalent number of driven roller conveyors 20, 120 to receive each line of produce 4, 104 exiting those channels 14, 114 or respective transition channels 124. Furthermore, while roller conveyors have been exemplified in the Figures, it can be understood by a person skilled in the art that other conveyors could be used.

Using an apparatus 2, 102 as described herein allows the aligning of the produce 4, 104 into one or more lines at high speeds effectively and efficiently, for example at speeds between 30 to 50 pieces per sec, without damaging the produce 4, 104 which is faster, more efficient and less damaging than conventional singulators using belt conveyors. The applicant has found this apparatus 2, 102 to be particularly effective for fresh fragile produce, such as berries, and the speed at which this produce would travel is estimated to be at about 45 pieces per second. The operation of the apparatus 2, 102 is also not affected by orchard waste and produce fluid (sugars), which is an issue which affects the operation of belt conveyors.

In an example use of the invention, fresh produce such as blueberries, are deposited in the second hopper 18 which mechanically agitates the produce 4 to distribute it evenly across the second hopper floor. The mechanical agitation transports the produce 4 from an open end of the second hopper 18 as a uniform bulk flow which is received in the entry end portion 10 of the first hopper 8 via the downwardly inclined ramp-like transition portion 22.

Mechanically agitating the first hopper 8 causes the bulk produce 4 to move as a flow from an entry end portion 10 towards the opposite exit end portion 12 such that the produce 4 settles into the channels 14 via the guiding portions 16 so that the produce 4 is guided into lines by the valleys formed by the walls of each channel 14.

Each piece of produce 4 thus exits the first hopper 8 from each of the two channels 14 as two uniformly distributed lines which can then be received by respective roller conveyors 20. As the roller conveyors 20 are upwardly inclined to match the height at which the produce 4 exits the channels 14, the produce 4 can be drawn up onto the roller conveyors 20 without damage, efficiently and quickly. The roller conveyors 20 can then easily and at speed transport the produce 4 for inspection by the grading system.

In a further example use of the invention, fresh produce such as blueberries, are deposited in the hopper 108 which mechanically agitates the produce 104 so that the bulk produce 104 to move as a flow from an entry end portion 110 towards the opposite exit end portion 112 such that the produce 104 settles into the channels 114 via the guiding portions 116 so that the produce 104 is guided into lines by the valleys formed by the walls of each channel 114.

Each piece of produce 104 thus exits the hopper 108 from each of the two channels 114 as two uniformly distributed lines which can then be received by respective transition channels 124. The non-agitated, i.e., stationary, transition channels 124 eliminate the bounce and randomness of the produce feed and furthermore the speed of the produce 104 is matched to the speed of the roller conveyors 120 by the action of the air flow exiting from the air outlet 126 which is located intermediate the channels 114 and respective channels 124. The downward incline of transition channels 124 also assist in increasing the speed of the produce flow. In an embodiment, the transition channels 124 may be mechanically-agitated.

As the roller conveyors 20 are upwardly inclined to match the height at which the produce 4 exits the channels 14, the produce 4 can be drawn up onto the roller conveyors 20 without damage, efficiently and quickly. The roller conveyors 20 can then easily and at speed transport the produce 4 for inspection by the grading system.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments. While two consecutive hoppers 8, 18, and a single hopper 108 are exemplified in the Figures, more hoppers, either mechanically agitated or non-agitated, may be included depending on the physical characteristics of the produce 4. It will also be understood by a person skilled in the art that the apparatus 2 would also function as described above with a single hopper.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Australian patent application nos. 2017902208, filed Jun. 1, 2017, and 2017904546, filed Nov. 9, 2017, to which this application claims priority, are hereby incorporated herein by reference in their entireties. The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An apparatus for transforming a bulk flow of produce into a flow of produce aligned in one or more lines, the apparatus having at least one hopper which has differently configured opposing end portions arranged to allow the flow of produce from one end to the other, an entry end portion being adapted to receive the bulk produce and the exit end portion having at least one channel for guiding the produce therealong, wherein the at least one channel has a V-shaped cross-section defined by a pair of upwardly inclined walls forming a valley in which the produce is transportable by mechanical agitation from the entry end portion into and along the valley(s) such that the produce exits the hopper aligned in one or more lines, each line issuing from one of said at least one channel(s).

2. An apparatus according to claim 1, wherein the hopper has two or more said channels.

3. An apparatus according to claim 1, wherein the hopper has one or more guiding portion(s) intermediate the end portions, the or each guiding portion being adapted to guide the produce from the entry end portion into the respective channel(s).

4. An apparatus according to claim 3, wherein the or each guiding portion is in the form of an inclined ramp which tapers in width into the respective channel(s).

5. An apparatus according to claim 1, wherein the produce exiting the or each channel is adapted to be received on a respective conveyor for transportation to a grading system.

6. An apparatus according to claim 5, wherein the apparatus has one or more transition channels, each transition channel being intermediate the or each channel of the hopper and a respective conveyor wherein the or each transition channel is adapted to guide the produce therebetween.

7. An apparatus according to claim 6, wherein the or each transition channel inclines downwardly from the channel of the hopper to the respective conveyor.

8. An apparatus according to claim 6, wherein each transition channel has a V-shaped cross-section defined by a pair of upwardly inclined walls forming a valley in which the produce is transportable.

9. An apparatus according to claim 6, having at least one air outlet arranged to deliver a flow of air, the or each air outlet being intermediate an exit end of the or each hopper channel and an entry end of the associated transition channel to direct air along the transition channel(s).

10. An apparatus according to claim 9, wherein the or each conveyor is inclined upwardly from the or each respective channel or transition channel to prevent the produce from dropping from the channel(s) or transition channel(s) onto the associated conveyor.

11. An apparatus according to claim 6, wherein the or each transition channel is mechanically-agitated.

12. An apparatus according to claim 6, wherein the or each transition channel is non-agitated.

13. An apparatus according to claim 11, wherein the inclination of the conveyor(s) is variable depending on the physical characteristics of the produce so as to allow each line of exiting produce to be drawn up onto the respective conveyor.

14. An apparatus according to claim 1, wherein the entry end portion of the hopper has a pair of upright walls with a generally horizontal floor extending therebetween.

15. An apparatus according to claim 1, wherein the apparatus has a further hopper, the further hopper being adapted to deliver the bulk produce into the first-mentioned hopper as a uniform flow.

16. An apparatus according to claim 15, wherein the further hopper is mechanically agitated.
